(19) United States
(12) Patent Application Publication
(10) Pub. No.: US 2012/0078875 A1
(43) Pub. Date: Mar. 29, 2012

(54) WEB BROWSER CONTACTS PLUG-IN

(76) Inventor: Michael Price, Marietta, GA (US)

(21) Appl. No.: 13/245,447

(22) Filed: Sep. 26, 2011

Related U.S. Application Data
(60) Provisional application No. 61/386,761, filed on Sep. 27, 2010.

(51) Int. Cl. G06F 17/30; G06F 15/16

(52) U.S. Cl. 707/709; 707/E17.108

(57) ABSTRACT

A system for collecting information from visited websites in a web browser. The system includes a web browser plug-in application having a set of user preferences for collecting certain target information from website. The system monitors the user navigating to one or more selected web-sites and parsing the websites for relevant target information. The system then compares the target information with the verified information stored in the database to generate relevant verified information. The user is alerted to the relevant verified website information and any target information that was not matched to the database. The user is then given the option of storing the relevant verified website information or searching for additional information. The unmatched information could potentially be crowd sourced to find the verified information or saved as verified information on its own. The user can then import the collected information into a workstation application.

### CROSS REFERENCE TO RELATED PATENT APPLICATIONS

This application claims the benefit under 35 U.S.C. §119 to Provisional Application Ser. No. 61/386,761, entitled “Web Browser Contacts Plug-In,” filed Sep. 27, 2010, the entire contents of which is hereby incorporated by reference.

### BACKGROUND OF THE INVENTION

### Technical Field

This invention relates generally to the field of web browsers and contact management systems. More specifically, an embodiment of the present invention is directed to a web browser plug-in tool for collecting information from third party websites for importation into a user's contact management system.

### Background

Modern business functions are heavily reliant on the World Wide Web. Corporate and third-party websites provide a wide variety of information regarding companies and an almost-innumerable list of functions, depending on the type of business and functionality a consumer or customer may need via the website (e.g., an airline website allows customers to search for and book flights via the Web, a retail website provides the possibility for a customer to order items via the Web, and banking and financial Web institutions provide their customers the ability to monitor their accounts, pay bills, or transfer funds and make changes to their accounts on-line).

The infrastructures for these websites also contain a wealth of information for those researching a company, including the names and contact information for a large number of employees of that company. Specifically, information regarding key executives and decision makers for a company may often be found through searches of websites, although such information may often be difficult to find.

Individuals who work in sales, consulting, or in any other of a wide variety of businesses rely heavily on networking and contacts. For such individuals information and the identity of key decision makers are necessities for modern business. The identity and contact information for these individuals can be difficult to find, however. Contact information may be included in a number of locations on the World Wide Web, including on a company website, social networking sites such as Facebook® or LinkedIn® or general directory sites such as YellowPages.com®. Contact information for a particular individual also may be available in all of these locations, and each may contain varied information. Therefore, it would be beneficial to have a plug-in tool operating within a Web browser that can search, mine and organize data and information from all of these websites.

### SUMMARY OF THE INVENTION

An embodiment of the invention includes a stand-alone software program that is loaded on the provider's server, cloud server(s) used by the provider, or a web hosting server of a corporate or other third party website, such as a social networking site or customer relationship management site (hereafter “server”). The server collects data from a website, wherein the server is in communication with a database and a network. Operable on the server is a web-crawler program for collecting site data from one or more target websites. The collected site data is stored in said database, which contains verified data and collected site data. Connected to the server via the network is a client computer. The client computer is in communication with the server and includes a web browser and a browser plug-in tool for collecting target data from one or more websites visited by the web browser. The plug-in tool is operable on the client computer and/or the server, wherein the plug-in tool analyzes and compares the target data with the verified data and the site data stored in the database, the plug-in tool alerts a user when the target data is matched in the database.

Another embodiment of the invention includes a plug-in for a Web browser such as Internet Explorer®, Apple® Safari®, Google Chrome®, or Firefox®, which said plug-in may interact with the stand-alone software loaded on the Server. Such a plug-in may communicate with the Server in order to acquire contact information of employees or decision-making individuals in organizations specified by the user. The plug-in may comprise a web-crawler computer program for collecting data from a web-site. The plug-in executing within a tangible storage medium readable by a processing circuit and storing instructions for execution by the processing circuit for performing a method. The method comprises accessing a target website on a client computer system connected to a network. Next, the target web-site is parsed for target information. If the target information is found, it is stored in a database containing verified information. The target information is compared with the verified information to generate a status condition. The user is alerted of the status condition. The method provides the user with an option of generating collection data or linking said target information with the verified information to generate verified data.

Another embodiment of the invention includes a plug-in for a Web browser such as Internet Explorer®, Apple® Safari®, Google Chrome®, or Firefox®. In this embodiment said plug-in may include a website crawling or search functionality for data mining in which the plug-in may search a site on which the server software is not installed and locate the necessary contact information specified by the user which the plug-in may display directly to the user or relay to the server for display back to the user. This method is implemented on a computer for collecting target information from a web-site through the web-browser plug-in. The plug-in accesses a target website and parses the web-site for target information. The target information is stored in a database containing verified information. The verified information is compared the target information to generate a status condition. The method alerts a user of the status condition, and provides the user with an option of generating collection data or linking the target information with the verified information to generate verified data.

### BRIEF DESCRIPTION OF THE DRAWINGS

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 is a flow-chart of a method for implementing a web browser plug-in tool in an end user computer, according to an embodiment.

FIG. 2 is a flow-chart of a method for implementing a web browser plug-in tool operable on a server, according to an embodiment.

FIG. 3 flow-chart of a method for implementing a web browser plug-in tool in a server and an end user computer, according to an embodiment.

FIG. 4 is a flowchart of a method for implementing a crowd-sourced information gathering solution, according to an embodiment.

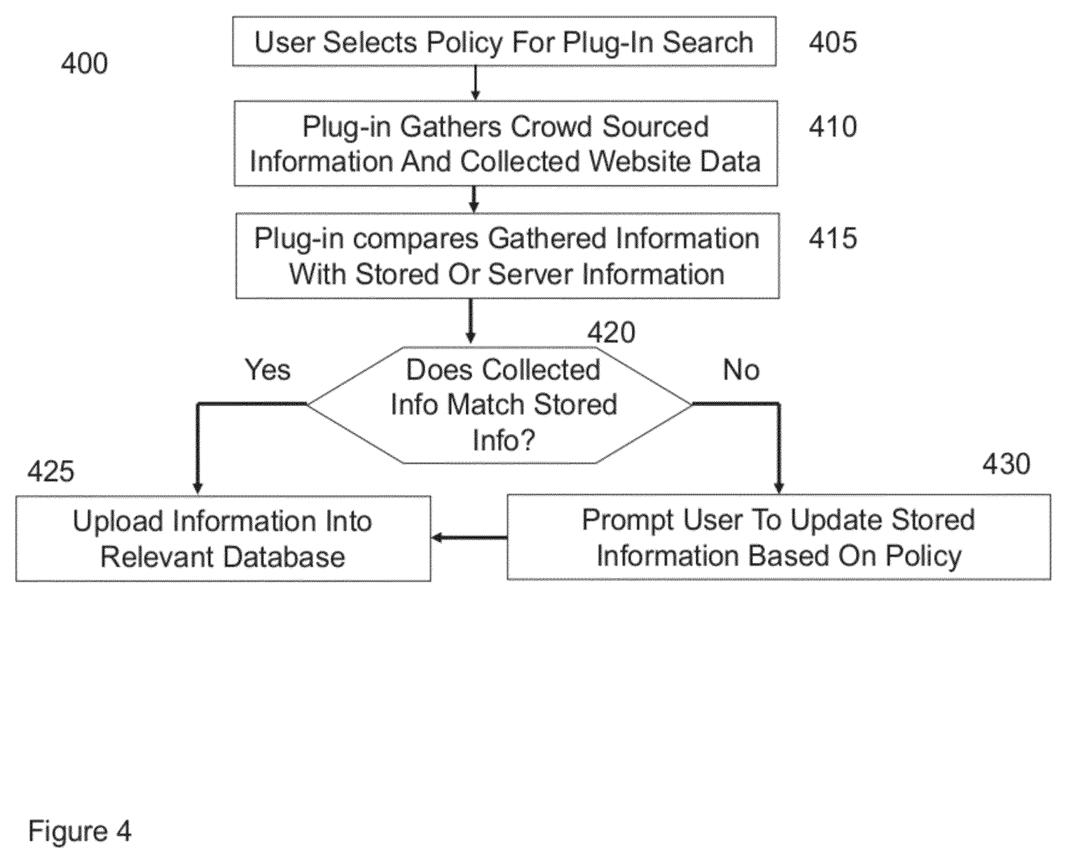

FIG. 5 is a flowchart of a method for implementing a peer information gathering solution, according to an embodiment.

FIG. 6 is a diagram illustrating an exemplary computing system, according to an embodiment.

FIG. 7 is an illustration showing a web browser with the plug-in tool, according to an embodiment.

### DESCRIPTION OF THE INVENTION

An embodiment of the invention described herein is a plug-in for a standard Internet, World Wide Web browser such as Internet Explorer®, Firefox®, Google Chrome®, or Safari®. Such a plug-in may run concurrently with the browser software. The plug-in is an extension of the host application, the web browser, and the plug-in depends upon the web browser to navigate to the target websites. An embodiment of the plug-in described herein comprises a web crawler computer program, which browses the World Wide Web in a methodical, automated manner. The web crawler gathers specific types of information from web pages such as contact names, contact titles, related social media addresses, phone numbers, temporary capture of emails for observation of formats, and other contact information. The plug-in may comprise one or more frameworks including C++, Delphi, Java, Python, Colony Framework, .NET, Applets, etc.

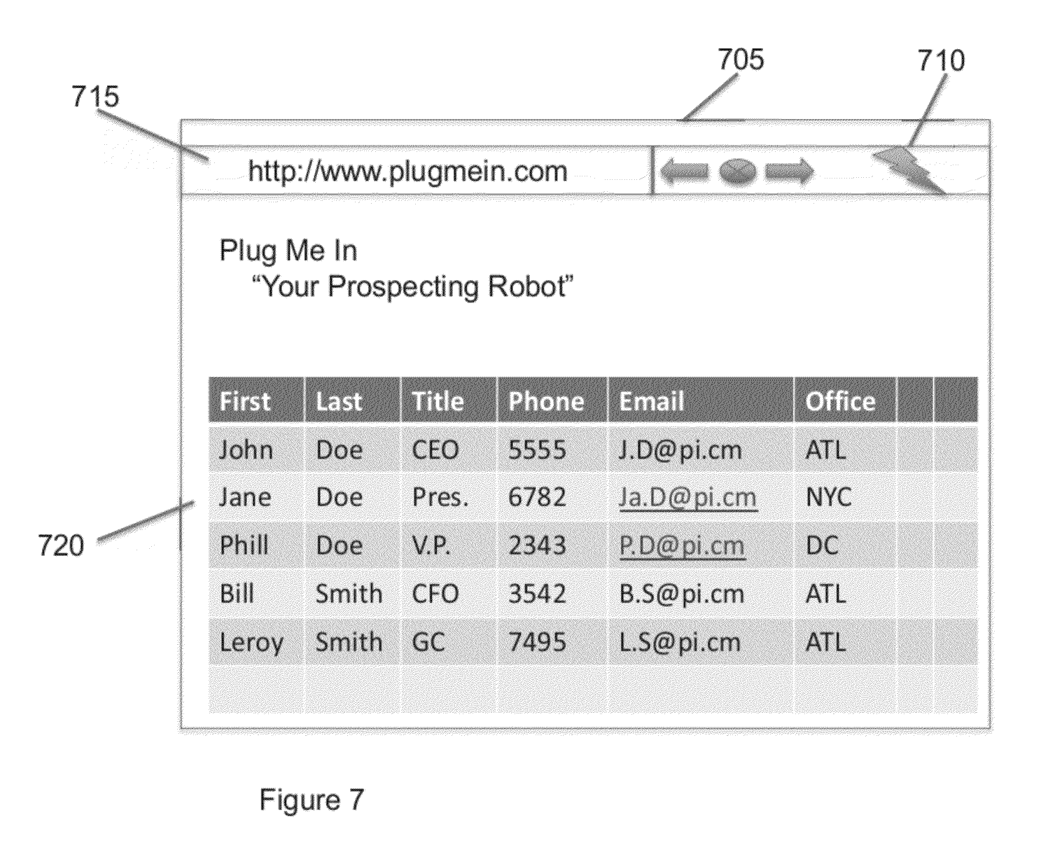

The user may set-up the plug-in as desired to search a website for any type of focused information search. FIG. 7 illustrates an exemplary embodiment with the plug-in tool 710 installed in a web browser 7105. In one embodiment, the user selects preferences for the plug-in to search for names, specific types of contacts, such as information technology managers or directors, human resources decision makers, or any other type of executive or decision maker contact relevant to the user's industry or business. The user may also specify preferences such that the plug-in will search, via a web crawling or other data mining functionality, for the peers or colleagues of a particular individual in a company's website, from a directory website, or from the individual's contacts on a social networking website. The plug-in may also relay the site's content to the host server for processing to identify names and titles for storing or display back to the user. Although embodiments of the invention disclose collecting contact information found on third party website, it should be noted that elements of this invention is applicable to almost any type of information found on any web page.

In addition to the plug-in 710, which executes along with the web browser software 705, the invention may include stand-alone software installed on the server. The installed software may be updated on a regular basis with contact information such that the plug-in 710 may communicate with it directly to retrieve specified contact information and data records. Such software and functionality allows for information retrieval without requiring execution of the web crawling or data mining functionality each time a user accesses a particular website. It will be understood by one of ordinary skill in the art that the functionality of the invention may be split between the Plug-In 710 and the server software and may be accomplished primarily by the Plug-In 710 when the server software is not installed. However, the server software, described below, may perform some of these functions.

The plug-in 710 disclosed herein functions as the user navigates a web browser 705 to a particular website 715. It will be understood by one of ordinary skill in the art that the user, when installing the plug-In 710, may set up his or her preferences the type of contacts, the type of information it will search for, and which target websites are of greatest interest. Similarly, preferences may be selected in the plug-In 710 for determining which database programs or contact management programs any found contact information should be uploaded to.

When the browser 705 loads a particular website, the plug-In 710 either parses the third party website, a company website URL, or page content to determine key matching criteria such as company, URL, name and/or location. The plug-In 710, as will be understood by one of ordinary skill in the art, may accomplish this task by initiating a web-crawl mechanism, which may initiate automatically or may be initiated by the user. The plug-In 710 then passes this to the server for the lookup, or passes the page or parts of a page's content to the server for parsing to determine such key matching criteria. Information that the plug-In 710 may pass to the server may include the URL, contact name, company, location, or other identifying information.

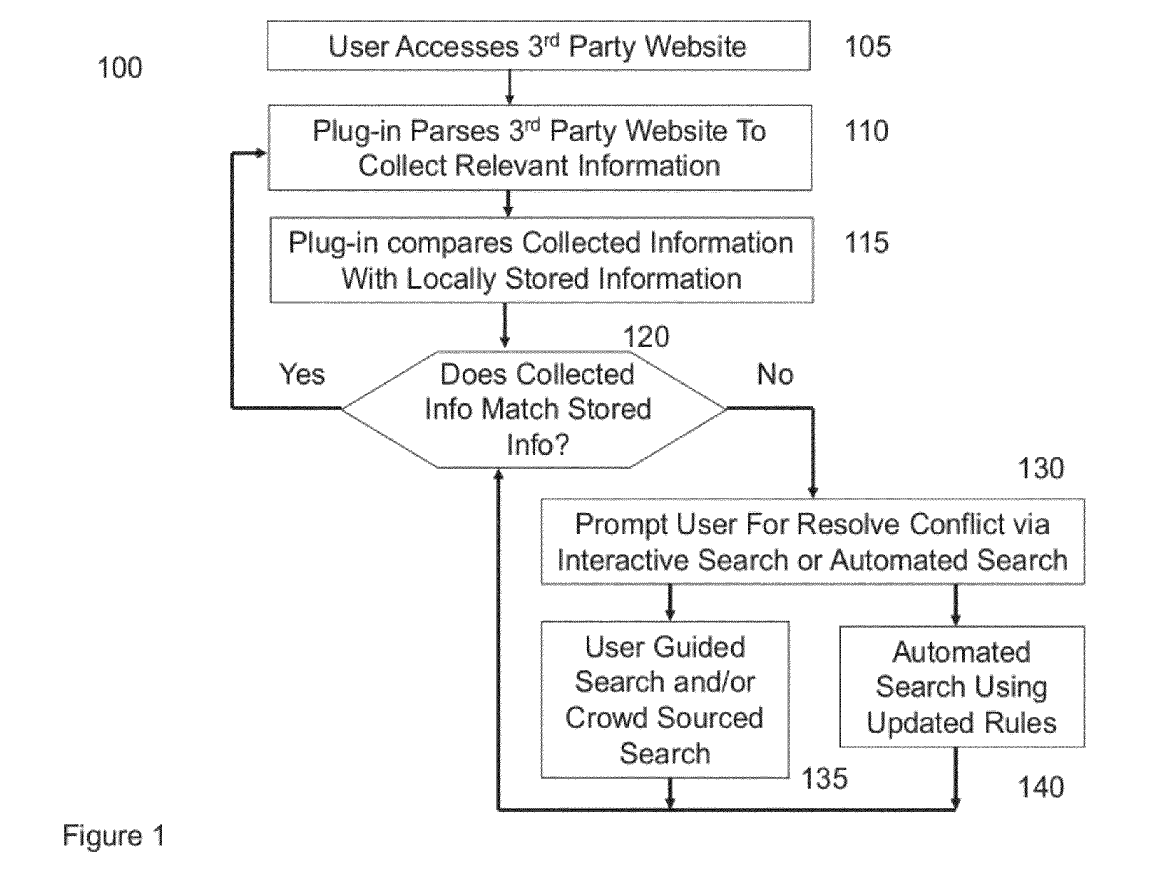

FIG. 1 illustrates an embodiment of the plug-in 100 operating within a web browser on a user's work station. When the plug-In 710 is installed, the user selects a set of preferences indicating the types of information the user is interested in gathering, the type of websites the user finds relevant, the types of industries and professionals the user may be interested in, etc. In this embodiment, when the user directs their browser to a website 105, the plug-In 710 begins parsing the website to collect relevant information 110. The plug-In 710 parses the web site using well know web crawler and/or data mining techniques. As the plug-In 710 gathers this data, the plug-In 710 compares the data with locally stored information 115. Some information gathered may already be available to the user, however other information may be new or different from what they user has stored on their work station. When the plug-In 710 discovers information that does not match 120 what is already locally stored within the user's work station, the user is prompted regarding the new or conflicting info 130. The user is then given the options of resolving the conflicts manually (e.g. deciding to upload the new information) or allowing the plug-In 710 to apply a set of rules to determine if the information is relevant for upload 140. This process continues as long as the user is working within their web browser.

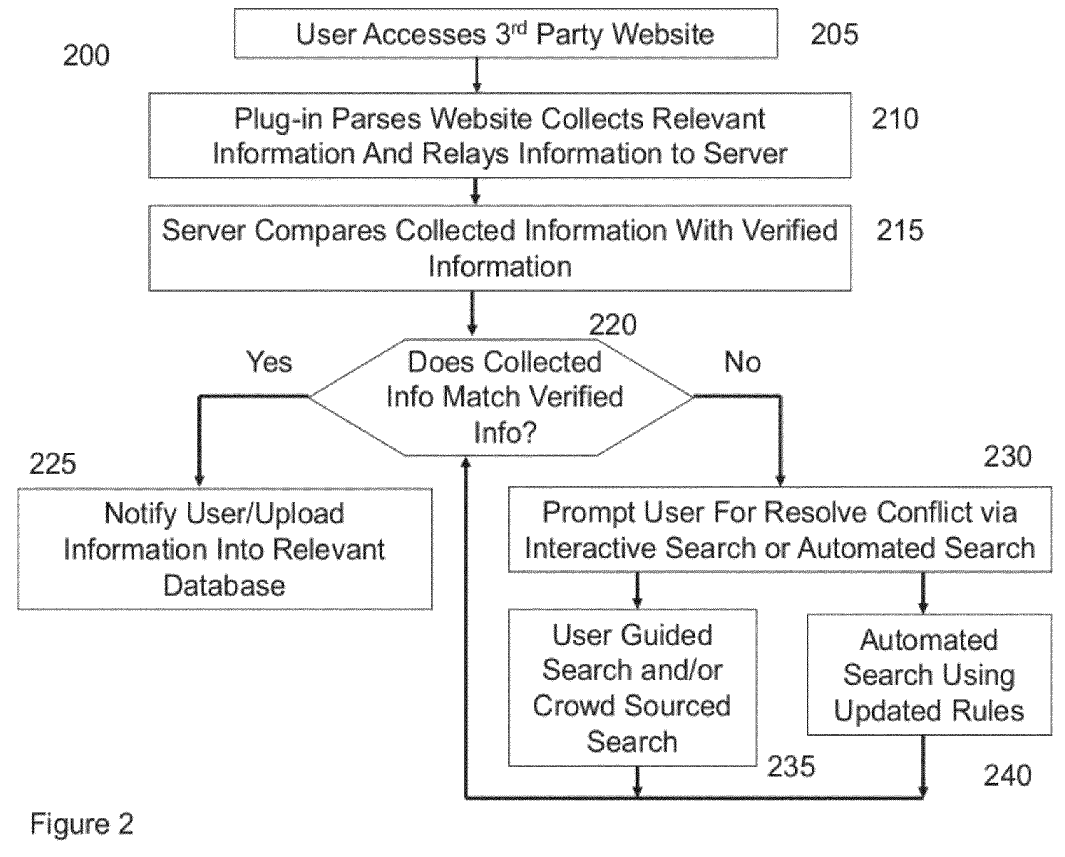

The plug-In 710 can also access verified information in a server system as illustrated in FIG. 2. When the user directs their browser to a website 205, the plug-In 710 begins to parse the website for relevant information 210 based on its set of preferences. The collected information is relayed over a network, for example, to a server system. The server may be an in house server local to the client or a third party server hosting specific information. In an exemplary embodiment, the server is a third party data base containing verified contact information. The plug-In 710 relays collected information, which is compared with the verified information as illustrated in step 215. The server system may have a set of policies that may determine the relayed information is more or less accurate than the verified information or it may determine that the collected information contains additional relevant data that is not found in the database. If the server determines the newly collected information is more relevant, it may upload this data into its databases. However, if the server does not consider the newly collected information to be more relevant, it may return what it believes to be more accurate information to the plug-In 710. When this information is relayed back to the plug-In 710 it determines if there is a match between the verified information and the collected information based in the user preferences as illustrated in step 220. If the information is determined to be a match, the user is notified and the information is uploaded into the user's database as illustrated in step 225. However, if the collected information is not a match, the user is prompted to resolve the conflict via interactive or automated search as illustrated in step 230. In step 235, the user is provided with a list of information items provided by the server, wherein the user can determine which information item is more accurate and relevant to the user. The user can select the item of their choice and the selected item is matched to the collected information found by the plug-In 710. Alternatively, the user may select a set of preferences for determining which information is most relevant to the user. They system can automatically search the information provided by the server based on these preferences as illustrated in step 240. The selected information is matched to the collected information found by the plug-In 710 and presented to the user in step 225.

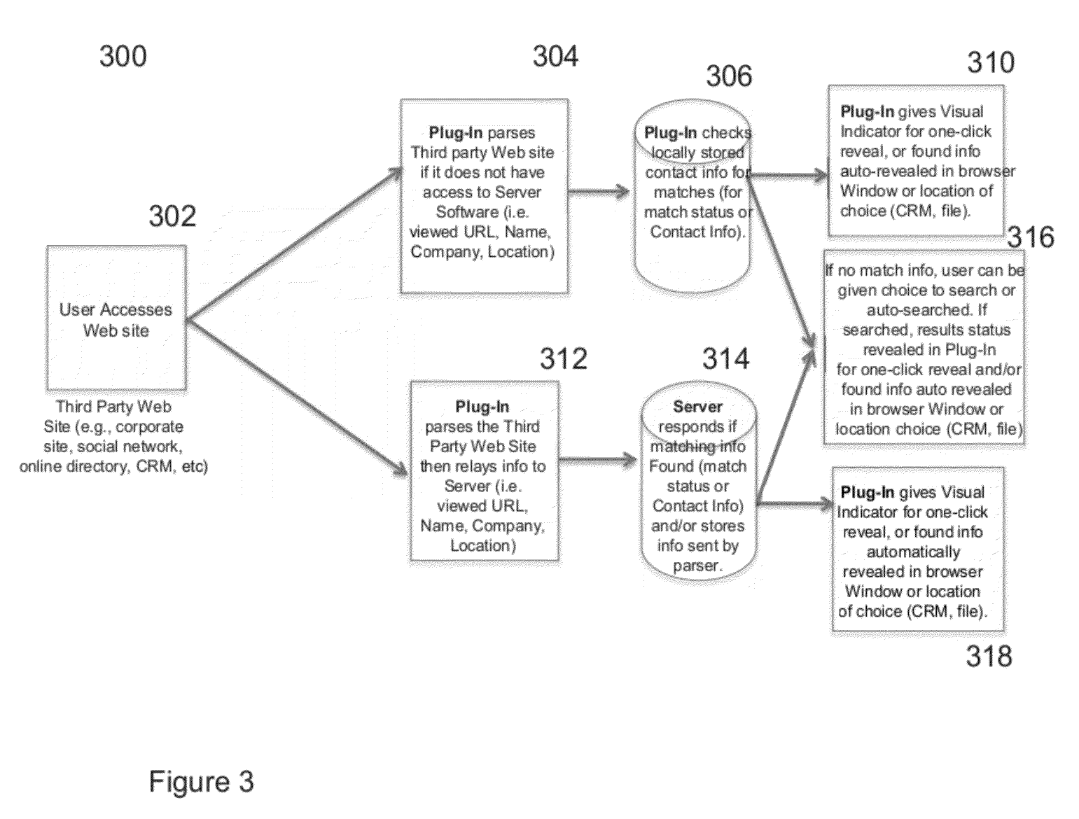

In an exemplary embodiment, both of these processes occur in parallel as illustrated in FIG. 3. The system 300 illustrates a system wherein the user accesses a third party website at step 302. The plug-In 710 parses the third party website for relevant collectable information at steps 312 and 304. The plug-In 710 checks locally stored information to verify matches with the collected information as shown in step 306. Similarly, the plug-In 710 can check the database in the server system for verified information for matches with the collected information as shown in step 314. Once found, the plug-In 710 notifies the user of the match as illustrated in steps 310 or 318. If there is no match the user is given the option of searching a list of archived information from the user's workstation or verified information from the server system as illustrated in step 316. In another embodiment, the database in the server system or the locally stored information may include a list of items for which information is missing; this list may be matched with the information parsed from the third party website. If there is a match, the parsed information may be used to complete the missing information.

In operation, the server may instantly respond to the plug-In 710 by serving the matching contacts or information; or the status indicating that matching information exists for display within the plug-In 710, the immediate browser window or into a new browser window. It will be understood by one of ordinary skill in the art that the plug-In 710 may display information or match status in the plug-In 710 or browser window with or without the user's input, and the user may specify a completely automated operation. For example at step 316, a browser window may display a visual indicator such as a “Found” button, a tab, or a link to the relevant information or type of information the user has specified, and the user may also have the option to review or automatically display the relevant information or other pertinent information. The user may then click on the visual indicator, tab or link, which shows a list of the found contacts and/or relevant information. The user may also have the option to narrow and parse the displayed data depending on preferences. Next the user may select the relevant information for individuals he or she wishes to save in their own database, whether the database tools are web-based or programs on the user's work station.

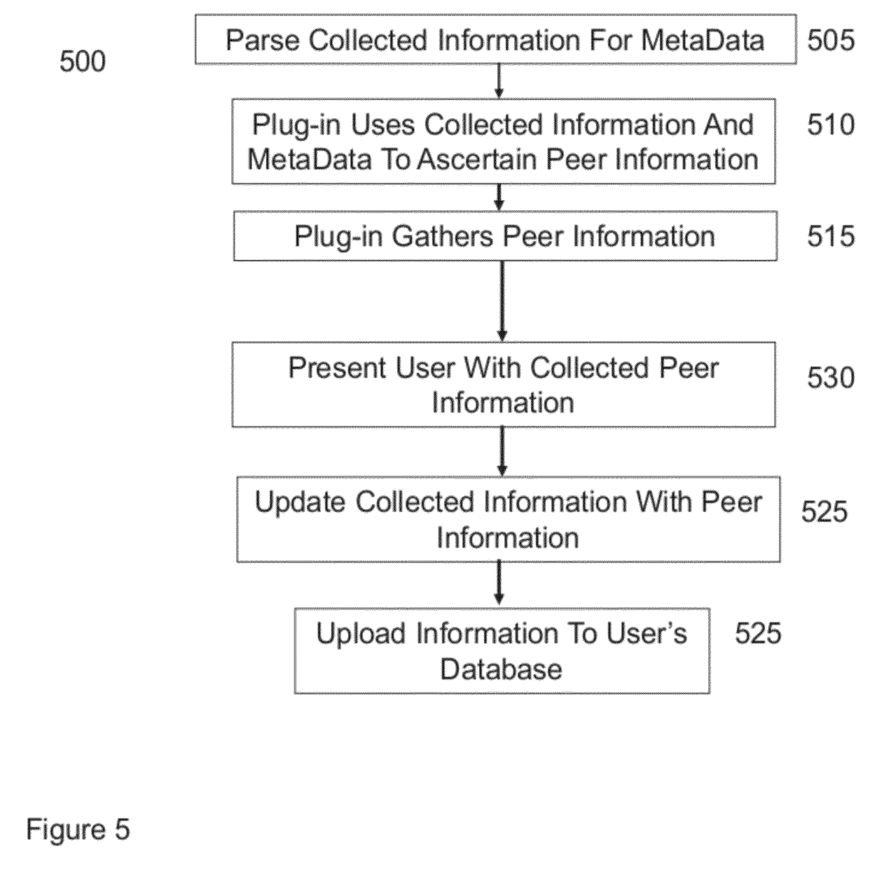

As described above in step 316, the user is usually given a set of verified information from the server or locally archived information from a user's work station to determine a match for the collected information found by the plug-In 710. However, FIG. 5, illustrates a method 400 wherein the collected information may be verified through crowd sourcing. In the embodiment, the user selects a policy for the plug-In 710 search shown in step 405. The plug-In 710 gathers crowd sourced information and collected website data (e.g. social media website data) as illustrated in step 410. The crowd sourced gathering of data could include an number of means, including instant messaging user contacts to request certain information, gathering data from crowd source websites or social media websites, generating inquires among a user's peers 720 to determine if other users in a peer relationship with the user have the relevant information in their contact data bases, gathering the data from other employees within the user's company, etc. Next the plug-In 710 compares the gathered crowd sourced data to the collected data to determine relevancy of the crowd sourced information as illustrated in step 415. The crowd sourced information is matched to the collected information in step 420. Matched information is uploaded to the user's information database in step 425. Information that does not match in presented to the user such that the user can verify their stored information manually as illustrated in step 430.

The information collected by the plug-In 710 may also be verified using peer data 720. FIG. 5 illustrates a method 500, wherein the plug-In 710 parses collected information for its metadata as shown in step 505. The plug-In 710 uses the collected information and metadata to ascertain peer or related data 720, as shown in step 510. In an exemplary embodiment, the peer data 720 can be, for example, a list other employees in the same company. Once the plug-In 710 determines similarities among peers, the plug-In 710 parses various websites to gather and collect the peer information 720 as shown in step 515. This collected peer information 720 is presented to the user as shown in step 530. Similarly, the user may be presented with this peer information 720 in steps 135, 140, 235, 240 and 316 above. The tool is then used to update this formation in step 525. Again, in practical application, this may occurs in steps 135, 140, 235, 240 and 316 above. Next the peer information 720 is uploaded into the user's database as shown in step 525.

In an exemplary embodiment, the user may also search based on an individual contact. For example, the user can find a particular contact, then navigate to a social networking site, such as LinkedIn®, and then find all of the contact's connections via the plug-In 710 of the invention is illustrated in step 510. The user may then sort and parse those contacts based on whichever narrowing factors the user chooses to add other individuals to their contact management program or customer relationship management tools, as would be done at step 515. Such a plug-In 710 allows the user to search any site for contact information of individuals, and may also allow searches based on specified search terms or based on relationship or similarity to contacts that the user already has. The benefit of such a plug-In 710 is that it automatically shows employees, names or relevant data from any website, and may also export it to the sites and programs that the user already employs, as illustrated by the list in step 530. Such a plug-In 710 will save the user a significant amount of time and effort in searching for, finding, or importing contacts for their business.

The user may also search a standard directory site, such as YellowPages.com®. When the user searches for a specific company or corporate listing from a directory website, the plug-In 710 disclosed herein will, as if the user had directed his or her browser to a specific site, automatically search the company's site or signal the server to do so, via the directory posting, for listings of employees and decision makers, or automatically show relevant information about that company being viewed in the standard directory site, as would be accomplished by steps 505-530 in FIG. 5.

The plug-In 710 of the invention is designed to be able to search, based on user preferences, through a variety of types of websites, locating decision-making individuals in an area of the organizational structure or particular resource group. The plug-In 710 may also store and pass the user's contact information so that it may also be passed to another customer relationship management site, server, or tool. The plug-In 710 allows for locating an individual, pulling the contact information of that individual and his or her peers and colleagues, and then exporting them to the user's own contact management software or websites. Because it functions as a plug-In 710 to a web browser, the plug-In 710 is compatible with all major browsers and work with all web directories, search engines, social networking sites, and individual company websites in whichever way that the user desires.

Because many or most websites frequently change their formats, the plug-In 710 retrieves or is sent updates from the server software so that it maintains accurate parsing/recognition of names, titles, companies, locations or other data across a multitude of third party sites and webmail systems without requiring the reinstallation of the plug-In 710 software. Also, there may be insufficient or old information on the server, therefore the relevant content served or the plug-In 710 may also have a button which causes it or signals the server to web data mine a company or other site, as described above, for new or updated names, addresses, phone numbers, faxes, emails and other relevant data for display and/or storage on-demand, or automatically based on the age or amount of information on the server. When a user updates information via the plug-In 710 interface, the plug-In 710 may also update the server with the new contact information for a particular individual, and, thus, the information may be passed to additional Websites.

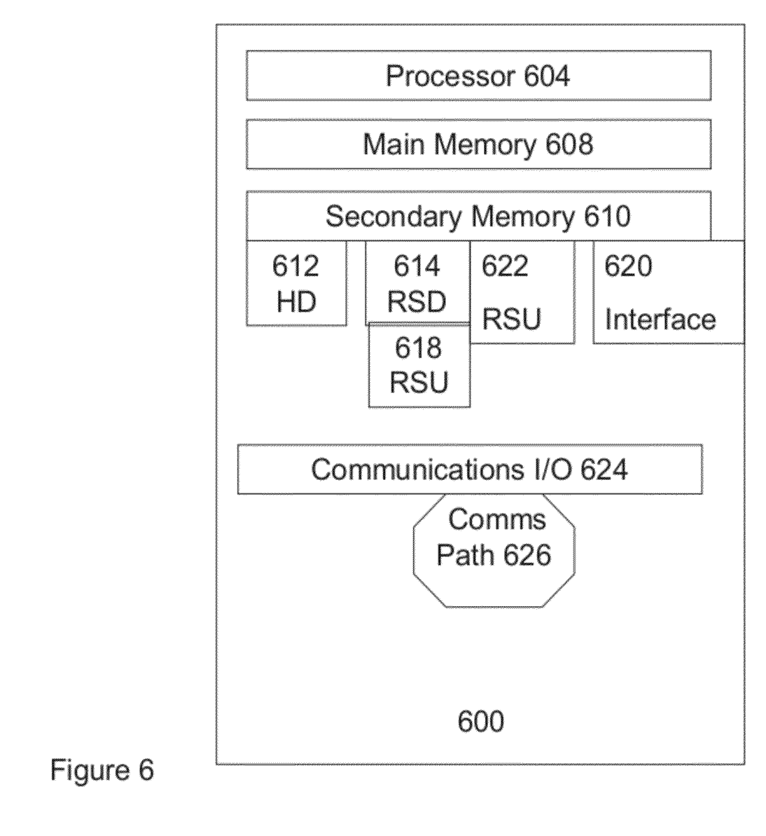

Various aspects of embodiments described herein can be implemented by software, firmware, hardware, or a combination thereof. FIG. 6 illustrates an example computer device/system 600 in which the embodiments, or portions thereof, can be implemented as computer-readable code. Various embodiments are described in terms of this example computer device/system 600. Computer device/systems 600, described herein may include any of a computer server, desktop, laptop, mobile phone, mobile, device, tablet computer, cloud computer, dumb terminal or any device cable of executing computer code, processing data and presenting processed data interactively with a user.

Computer system 600 includes one or more processors, such as processor 604. Processor 604 can be a special purpose or a general purpose processor. Processor 604 is connected to a communication infrastructure 606 (for example, a bus or network).

Computer system 600 also includes a main memory 608, such as random access memory (RAM), and may also include a secondary memory 610. Secondary memory 610 may include, for example, a hard disk drive 612 and/or a removable storage drive. Removable storage drive 614 may include a floppy disk drive, a magnetic tape drive, an optical disk drive, a flash memory, or the like. The removable storage drive 614 reads from and/or writes to removable storage unit 618 in a well-known manner. Removable storage unit 618 may include a floppy disk, magnetic tape, optical disk, etc. which is read by and written to by removable storage drive 614. As will be appreciated by persons skilled in the relevant art(s), removable storage unit 618 includes a computer readable storage medium having stored therein computer software and/or data.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between computer system 600 and external devices. Communications interface 624 may include a modem, a network interface (such as an Ethernet card), a communications port, a PCMCIA slot and card, or the like. Software and data transferred via communications interface 624 are in the form of signals which may be electronic, electromagnetic, optical, or other signals capable of being received by communications interface 624. These signals are provided to communications interface 624 via a communications path 626. Communications path 626 carries signals and may be implemented using wire or cable, fiber optics, a phone line, a cellular phone link, an RF link or other communications channels.

In this document, the terms “computer program product” and “computer readable medium” are used to generally refer to storage media such as removable storage unit 618, removable storage unit 622, and a hard disk installed in hard disk drive 612. Computer program product and computer readable medium can also refer to one or more memories, such as main memory 608 and secondary memory 610, which can be memory semiconductors (e.g. DRAMs, etc.). These computer program products are means for providing software to computer system 600.

Computer programs (also called computer control logic) are stored in main memory 608 and/or secondary memory 610. Computer programs may also be received via communications interface 624. Such computer programs, when executed, enable computer system 600 to implement the embodiments as discussed herein. In particular, the computer programs, when executed, enable processor 604 to implement the processes of embodiments, such as the steps in the methods discussed above. Accordingly, such computer programs represent controllers of the computer system 600. Where embodiments are implemented using software, the software may be stored in a computer program product and loaded into computer system 600 using removable storage drive 614, interface 620, or hard drive 612.

Embodiments may also be directed to computer products having software stored on any computer readable medium. Such software, when executed in one or more data processing devices, causes a data processing device(s) to operate as described herein.

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A system for collecting data from a website, comprising:
a server system in communication with a database and a network, wherein said server contains a web-crawler program for collecting site data from one or more target websites, wherein in the collected site data is stored in said database;
said database containing verified data and collected site data;
a client computer in communication with said server and said network, wherein said client computer includes a web browser and a browser plug-in tool for collecting target data from one or more websites visited by said web browser;
said plug-in tool operable on said client computer and/or said server system, wherein said plug-in tool analyzes and compares said target data with said verified data and said site data stored in said database, said plug-in tool alerting a user when said target data is found and/or matched in said database.

2. The system according to claim 1, further comprising:
said plug-in tool visually alerting said user of a match between said target data and said verified or site data stored in said database.

3. The system according to claim 2, further comprising:
said plug-in tool providing said user with the option of linking said matched target data with said verified or site data stored in said database.

4. The system according to claim 3, further comprising:
said plug-in tool importing said matched target data into a contact management application operable on said client computer and/or said server system.

5. The system according to claim 1, further comprising:
said plug-in tool using said target data to parse said site data and said verified data to determine peer or group relationship data among said target, site and verified data.

6. The system according to claim 5, further comprising:
said plug-in tool using said peer or group relationship data to determine key statistics among said target, site and verified data.

7. A web-crawler computer program for collecting data from a web-site, using a web-browser plug-in, comprising a tangible storage medium readable by a processing circuit and storing instructions for execution by the processing circuit for performing a method comprising:
accessing a target website on a client computer system connected to a network;
parsing said target web-site for target information;
storing said target information in a database containing verified information;
comparing said target information with said verified information to generate a status condition;
alerting a user of said status condition, and providing said user with an option of generating collection data or linking said target information with said verified information to generate verified data.

8. The web-crawler computer program according to claim 7, further comprising:
providing a visual and/or audio alert to said user of said status condition.

9. The web-crawler computer program according to claim 8, further comprising:
providing said user with the option of verifying said status condition with a crowd sourced information update.

10. The web-crawler computer program according to claim 7, further comprising:
importing said verified data into a contact management application.

11. The web-crawler computer program according to claim 7, further comprising:
said web-browser plug-in using said target information to parse said verified information data to determine peer or group relationship data.

12. The web-crawler computer program according to claim 11, further comprising:
said web-browser plug-in using said peer or group relationship data to determine key statistics among said target and verified information.

13. A computer-implemented method of collecting target information from a web-site through a web-browser plug-in, said method comprising:
accessing a target website;
parsing said web-site for target information;
storing said target information in a database containing verified information;
comparing said target information with said verified information to generate a status condition;
alerting a user of said status condition, and providing said user with an option of generating collection data or linking said target information with said verified information to generate verified data.

14. The method according to claim 13, further comprising:
providing a visual and/or audio alert to said user of said status condition.

15. The method according to claim 13, further comprising:
providing said user with the option of verifying said status condition with a crowd sourced information update.

16. The method according to claim 13, further comprising:
importing said verified data into a contact management application.

17. The method according to claim 13, further comprising:
said web-browser plug-in using said target information to parse said verified information data to determine peer or group relationship data.

18. The method according to claim 17, further comprising:
said web-browser plug-in using said relationship data to determine key statistics among said target and verified information.

19. The method according to claim 17, wherein the said plug-in is executed on one or more cloud server systems.

20. The method according to claim 17, wherein the said plug-in is executed on a client computer system.
